(19) United States
(12) Patent Application Publication
(10) Pub. No.: US 2020/0327511 A1
(43) Pub. Date: Oct. 15, 2020

(54) MULTIPLE AUTHENTICATION METHOD FOR DIGITAL ASSET TRANSACTION

(71) Applicant: CoolBitX Ltd., Grand Cayman (KY)

(72) Inventors: Jay ZHUANG, Taipei City (TW); Shih-Mai OU, Taipei City (TW)

(73) Assignee: CoolBitX Ltd., Grand Cayman (KY)

(21) Appl. No.: 16/379,505

(22) Filed: Apr. 9, 2019

(51) Int. Cl. G06Q 20/06; H04L 9/08; H04L 29/06; H04L 9/30; G06Q 20/38

(52) U.S. Cl. CPC G06Q 20/065; H04L 9/0897; H04L 63/0884; G06Q 2220/00; G06Q 20/3829; G06Q 20/3825; H04L 9/30

(57) ABSTRACT

A multiple authentication method of the present invention comprises the following steps: an authentication server terminal obtains an authentication address by performing authentication on a digital currency account; a transaction item is created by an electronic device, and the transaction server terminal generates matching information and sends the matching information to the electronic device; that set amount is consistent with transaction amount of the matching information is confirmed to transmit an electronic signature to the electronic device; the authentication server terminal sends a license signature to the electronic device after confirming the transaction address of the matching information is consistent with the authentication address; the electronic device obtains the matching information, the electronic signature and the license signature to instruct the transaction server terminal to perform the digital currency transaction. In this way, the user is effectively assisted in identifying the transaction object and avoiding transactions with an unidentified object.

### FIELD OF THE DISCLOSURE

The present disclosure relates to a digital asset transaction method capable of reducing the risk of being stolen in digital assets, and more particularly, to a multiple authentication method for digital asset transaction capable of making confirmation on transaction content and transaction addresses

### BACKGROUND

To allow consumers to go out without having to carry cash for taking public transportation or making purchases in various stores, the use of digital assets for transaction thus has gradually become a trend in society. Wherein on the present market, there are electronic transaction devices that often use digital assets (e.g., electronic currency), such as electronic wallets, credit cards, stored value cards, and easycards.

When a consumer purchases a digital asset for deposit, the digital asset purchased by the consumer would be stored in a transaction server terminal connected to the network, and the electronic transaction device would be stored with a piece of amount information about the amount of the digital assets; when a consumer wants to conduct consumption transactions through an electronic transaction device, the electronic transaction device will be connected to the transaction server terminal via a card reader, so that the digital asset is transferred on the transaction server terminal, and the amount information is updated to indicate the amount of the remaining digital assets.

However, at present, the digital assets are transacted on the transaction server terminal, and the transaction server terminal is continuously connected to the Internet, such that if there is flaws in the protection device for digital asset security (for example, a firewall), the person having other intentions (e.g., hackers), besides being able to directly implant a stolen programs through the internet, also can steal digital assets through the flaws of protection devices, thus causing financial losses to consumers.

### SUMMARY

The main purpose of the present invention is that a user oneself is able to confirm whether the transaction amount and the transaction address are correct via the electronic device, and besides, the authentication server terminal can also assist the user in confirming whether the transaction address has been authenticated and further determining whether the transaction address is from a non-problematic digital currency account. Thus, when making a transaction in digital currency, the chance that both the information content of the transaction amount and the transaction address are falsified will be greatly reduced, besides, the digital currency of the digital currency account will not be transferred to an unauthenticated digital currency account, thus avoiding digital asset transactions with unidentified objects.

To achieve above-mentioned purpose, the present invention relates to a multiple authentication method for digital asset transaction, and the method comprises the following steps: a setting up step, an account authentication step, a transaction matching step, a transaction confirming step, an account confirming step and a transaction step.

In the present embodiment, the setting up step is as follows: creating a digital currency account capable of storing digital currency, the digital currency account having public a piece of key information and a piece of private key information, and store the private key information in a storage carrier; the account authentication step is as follows: an authentication server terminal receives the public key information and performs authentication on the public key information to obtain an authentication address, wherein the authentication server terminal has a license signature, and is able to be used to verify whether the public key information and the authentication address match with each other. In the present embodiment, the authentication server terminal connects to a plurality of various transaction institutions, and the transaction institution can create the digital currency account, thus further generating the public key information and the private key information. Wherein when the transaction institution generates the public key information, the transaction institution transmits the public key information to the authentication server terminal, and thus the authentication server terminal authenticates the public key information.

Wherein, the transaction matching step is as follows: an electronic device obtains the public key information and creates a transaction item including a public key address and a set amount according to the public key information, and the electronic device transmits the transaction item to a transaction server terminal, and accordingly the transaction server terminal matches the transaction items of various users to form a piece of matching information including a transaction address as well as a transaction amount and transmits the matching information to the electronic device; the transaction confirming step is as follows: verifying that the set amount of the transaction item is consistent with the transaction amount of the matching information, which makes the storage carrier generate a electronic signature corresponding to the private information and transmit the electronic signature to the electronic device.

In the present embodiment, in the transaction confirming step, one of the electronic device and the storage carrier obtains the set amount of the transaction item and the transaction amount of the matching information, and performs verification between the set amount of the transaction item and the transaction amount of the matching information.

Furthermore, in the transaction confirming step, before the electronic signature is transmitted to the electronic device, the other one of the electronic device and the storage carrier re-verifies that the set amount is consistent with the transaction amount of the matching information, furthermore, one of the electronic device and the storage carrier receives a confirmation indication inputted by the user, while the other one of the electronic device and the storage carrier receives a re-confirmation indication, and accordingly the electronic device and the storage carrier sequentially verify that the set amount is consistent with the transaction amount of the matching information.

Furthermore, the account confirming step is as follows: the electronic device transmits the transaction address of the matching information to the authentication server terminal, and the authentication server terminal performs verification between the transaction address and the authentication address to confirm that the transaction address is consistent with the authentication address, and accordingly the authentication server terminal transmits the license signature to the electronic device; and the transaction step is as follows: after obtaining the matching information, the electronic signature and the license signature, the electronic device generates transaction instruction and transmits the transaction instruction to the transaction server terminal to transfer the digital currency of the public key information.

In another preferred embodiment, the multiple authentication method for digital asset transaction further comprises a transaction item verifying step and a transaction item re-verifying step. Wherein the transaction item verifying step is as follows: the electronic device obtains the set amount and the public key address, and the electronic device confirms that the set amount and the public key address have no errors to generate verification information, and accordingly the electronic device transmits the transaction item to the transaction server terminal.

Furthermore, the transaction item re-verifying step is as follows: when the electronic device generates the verification information, the electronic device transmits the transaction item to the storage carrier, and the storage carrier obtains the set amount and the public key address and confirms that the set amount and the public key address have no errors to generate a piece of re-verification information transmitted to the electronic device, and thus the electronic device can transmit the transaction item to the transaction server terminal.

As can be seen from above explanation, the present invention has the characteristic that before performing the transaction step, the transaction confirming step and the account confirming step need to be performed; after a user oneself confirms that the transaction amount and the transaction address are correct, the storage carrier transmits the electronic signature to the electronic device, and furthermore, the authentication server terminal would also assist the user in confirming that the transaction address has been authenticated, and then the authentication server terminal transmits the license signature to the electronic device, such that the electronic device must obtain the electronic signature and the license signature to further instruct the transaction server terminal to transfer the digital currency of one piece of the public key information to another piece of public key information. Through it, the user oneself can make first confirmation on the transaction condition, and then the authentication server terminal makes second confirmation on the address of the transaction object, thereby effectively assisting the user in identifying the identity of the transaction object and avoiding the digital asset transaction with the unidentified object. Therefore, when making digital currency transactions, the chance that both the information content of the transaction amount and the transaction address are falsified will be greatly reduced, and besides, the digital currency of the digital currency account will not be transferred to an unauthenticated digital currency account, thus avoiding digital asset transactions with unidentified objects.

### BRIEF DESCRIPTION OF THE DRAWINGS

Accompanying drawings are for providing further understanding of embodiments of the disclosure. The drawings form a part of the disclosure and are for illustrating the principle of the embodiments of the disclosure along with the literal description. Apparently, the drawings in the description below are merely some embodiments of the disclosure, a person skilled in the art can obtain other drawings according to these drawings without creative efforts. In the figures:

FIG. 1 is a schematic illustrating flowchart of the multiple authentication method for digital asset transaction;

FIG. 2 is a schematic illustrating modular view of the multiple authentication transaction system of digital asset;

FIG. 3 is a schematic illustrating the setting up step in the FIG. 1;

FIG. 4 is a schematic illustrating the account authentication step in the FIG. 1;

FIG. 5 is a schematic illustrating the transaction item verifying step in the FIG. 1;

FIG. 6 is a schematic illustrating the transaction item re-verifying step in the FIG. 1;

FIG. 7 is a schematic illustrating the transaction matching step in the FIG. 1;

FIGS. 8A and 8B are schematic illustrating the transaction confirming step in the FIG. 1;

FIG. 9 is a schematic illustrating the account confirming step in the FIG. 1;

and

FIG. 10 is a schematic illustrating the transaction step in the FIG. 1.

### DETAILED DESCRIPTION OF PREFERRED EMBODIMENTS

In order to further understand the structure, usage and features of the present invention more clearly, the present invention is described in detail below with references to the accompanying drawings and specific preferred embodiments:

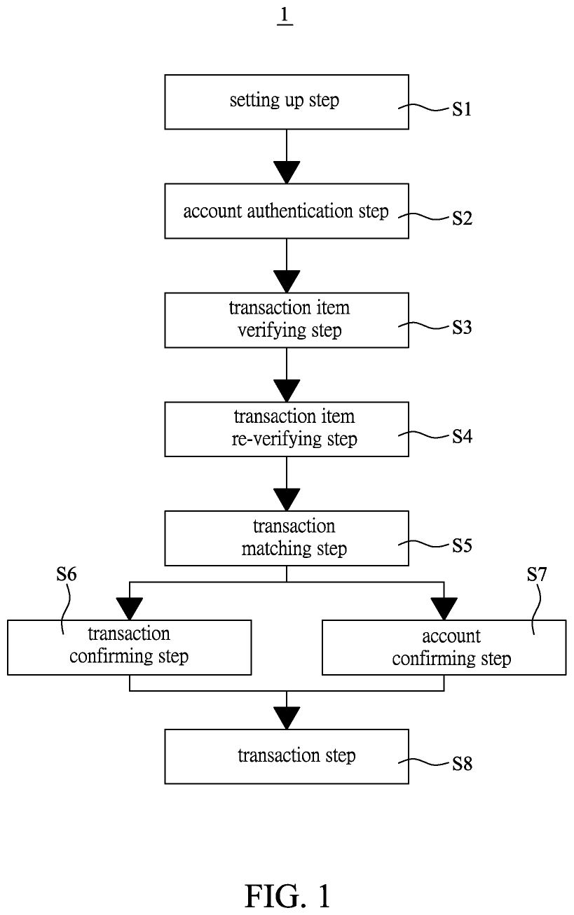

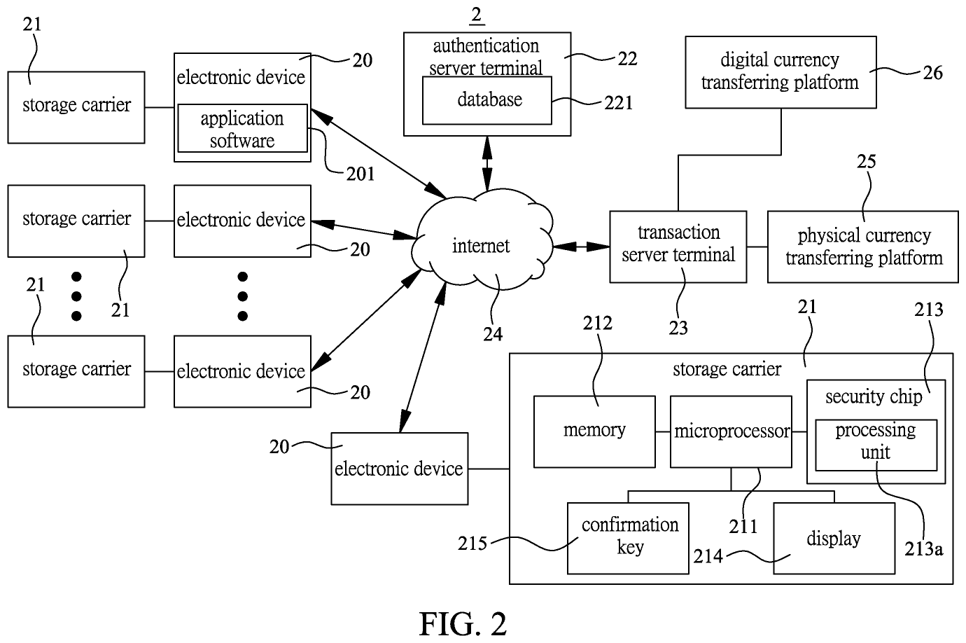

Please refer to FIGS. 1 and 2. A multiple authentication method for digital asset transaction 1 of the present invention is used in conjunction with a multiple authentication transaction system of digital asset 2. As shown in FIG. 2, the multiple authentication transaction system of digital asset 2 has a plurality of electronic devices 20, a plurality of storage carriers 21, an authentication server terminal 22 and a transaction server terminal 23, wherein each the electronic device 20 is installed with a piece of application software 201; each the electronic device 20 can actively connect to the internet 24; the internet 24 simultaneously connects to the authentication server terminal 22 and the transaction server terminal 23, such that all the electronic devices 20 can connect to the authentication server terminal 22 and the transaction server terminal 23 through the internet 24. In the present embodiment, the electronic device 20 may be set as a cellphone, a computer or a tablet.

Each the storage carrier 21 cannot be directly and actively connected to the internet 24, but each the storage carrier 21 can be selectively one-to-one connected or disconnected to one of the plurality of the application software 201. And when the storage carrier 21 is connected to the application software 201, the storage carrier 21 can be connected to the internet 24 via the electronic device 20. Wherein, each the storage carrier 21 is equipped with a microprocessor 211 capable of processing information, a memory 212 capable of storing information, a security chip 213 for storing important information, a display 214 capable of displaying information content and a confirmation key 215 capable of confirming whether the information content is correct. The memory 212, the security chip 213, the display 214 and the confirmation key 215 four all are electrically connected to the microprocessor 211. Wherein, the security chip 213 has a processing unit 213a capable of processing information, and in this embodiment, the storage carrier 21 is configured as an integrated circuit (IC) card.

As shown in the figure, the authentication server terminal 22 has a database 221 capable of storing information, and the transaction server terminal 23 connects to a physical currency transferring platform 25. The transaction server terminal 23 is stored with a plurality of transaction items of various users, wherein each transaction item has a set amount and a public key address. Furthermore, the transaction server terminal 23 connects to a digital currency transferring platform 26, and the digital currency transferring platform 26 is set as a blockchain.

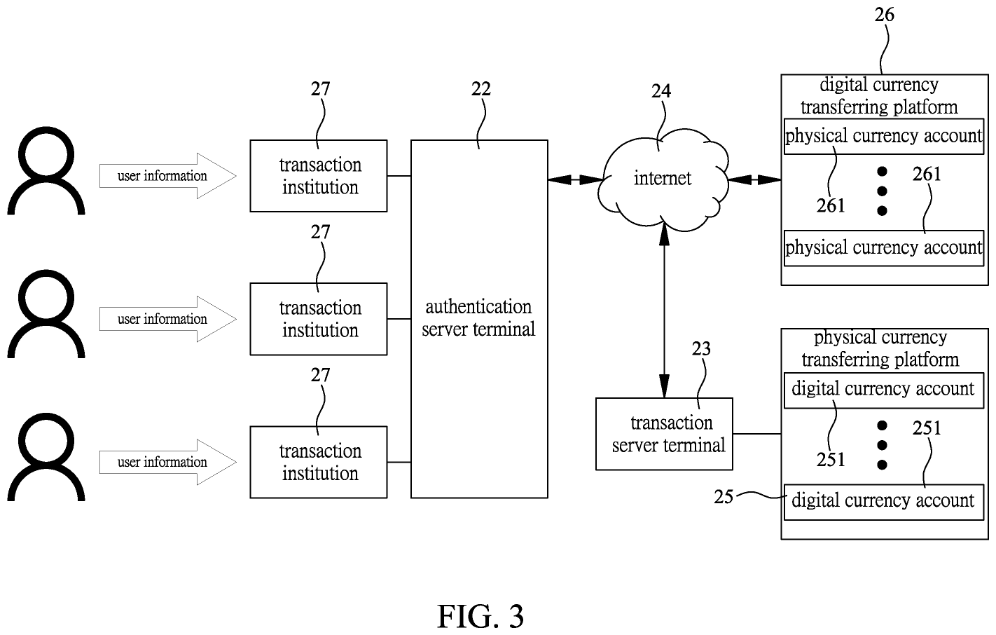

Please refer to FIGS. 1 and 3. A plurality of transaction institutions 27 of various systems are connected to the authentication server terminal 22, and when a plurality of users want to apply for the storage carrier 21 for digital asset transaction, each user first provides user information indicating the user's personal data to one of the transaction institutions 27. When the transaction institution 27 receives the user information, the transaction institution 27 creates a physical currency account 251 set up on the physical currency transferring platform 25 and a digital currency account 261 set up on the digital currency transferring platform 26 according to the user information. The digital currency account 261 has private key information and public key information, and the transaction institution 27 then sends the private key information and the public key information to one of the storage carrier 21. Accordingly, the private key information is stored in the security chip 213 of the storage carrier 21; the public key information is stored in the memory 212 of the storage carrier 21. Thus, a setting up step S1 is completed. Subsequently, the storage carrier 21 stored with the private key information is handed to the user. In the present embodiment, the private key information is used to authorize the transfer of digital currency, and the public key information shows the total amount of the digital currency and the public key address of the digital currency account 261. Wherein, the physical currency account 251 is one-to-one corresponding to the digital currency account 261, and the physical currency account 251 is used to store physical currency (e.g., various national currency such as NTD, and US dollars), while the digital currency account 261 is used to store digital currency (e.g., virtual internet currency such as bitcoin) or electronic articles of value.

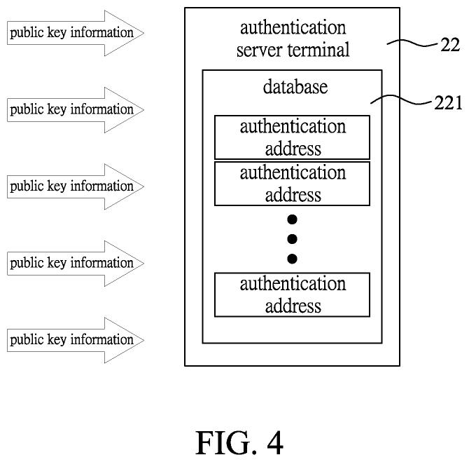

Please refer to FIGS. 1 and 4. Next, an account authentication step S2 is performed. When carrying out the account authentication step S2, the public key information of the digital currency account 261 is transmitted to the authentication server terminal 22, and the authentication server terminal 22 authenticates the public key information of the digital currency account 261, which makes the authentication server terminal 22 obtain the public key address of the public key information in the digital currency account 261. Furthermore, the authentication server terminal 22 stores the public key address of the public key information of the digital currency account 261 into the database 221 to form an authentication address, wherein the authentication server terminal 22 has a license signature indicating that the public key information in the digital currency account 261 has been authenticated. In the present embodiment, when the transaction institution 27 creates the digital currency account 261, the transaction institution 27 can immediately send the public key information of the digital currency account 261 to the authentication server terminal 22 for authentication; or after the digital currency account 261 is created, the user oneself provides the above public key information of the digital currency account 261 to the authentication server terminal 22 and makes the authentication server terminal 22 perform authentication.

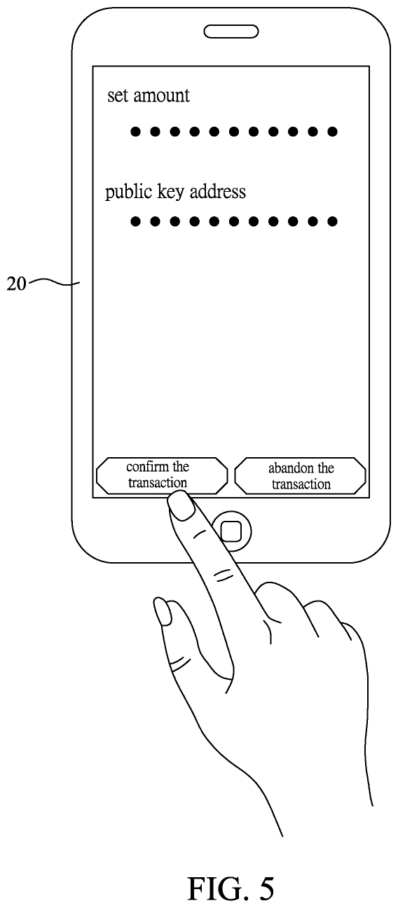

Please refer to FIGS. 1 and 5, after completing the account authentication step S2 and proceed to perform a transaction item verifying step S3. When performing the transaction item verifying step S3, the electronic device 20 held by the user is connected to the storage carrier 21 stored with the private key information, so that the application software 201 can be connected to the storage carrier 21; the electronic device 20 is connected to the authentication server terminal 22 and the transaction server terminal 23 via the internet 24, such that the storage carrier 21, the application software 201, the authentication server terminal 22 and the transaction server terminal 23 four all are in a connected state. Subsequently, the electronic device 20 can actively obtain the public key information of the digital currency account 261 from the storage carrier 21 and creates a transaction item including a public key address and a set amount according to the public key information through the application software 201. When the electronic device 20 creates the transaction item, from the transaction item, the electronic device 20 obtains the set amount of the transaction item as well as the public key address of the transaction item, and further shows the set amount as well as the public key address. Next, through the electronic device 20, the user views that whether both the information content of the set amount and the public key address have errors, and when the user confirms that both the information content of the set amount and the public key address are correct, the user presses the key “confirm the transaction” displayed on the electronic device 20, thus completing the transaction item verifying step S3. Through this, the electronic device 20 would generate verification information confirming that the set amount and the public key address have no errors; conversely, when the user confirm that both the information content of the set amount and the public key address are not correct, the user presses the key “abandon the transaction” displayed on the electronic device 20, which makes electronic device 20 not generate the verification information. Thus, the transaction item verifying step S3 would not be completed.

In the present embodiment, the transaction item may show the information content of buying the digital currency or the information content of selling the digital currency. Wherein when the transaction item shows the information content of buying the digital currency, the set amount would indicate the purchasing amount of buying the digital assets, and the public key address would indicate which digital currency account 261 the digital assets are to be transferred into. In addition, when the transaction item shows the information content of selling the digital currency, the set amount would indicate the selling amount of selling the digital assets, and the public key address would indicate which digital currency account 261 the digital assets are to be transferred out.

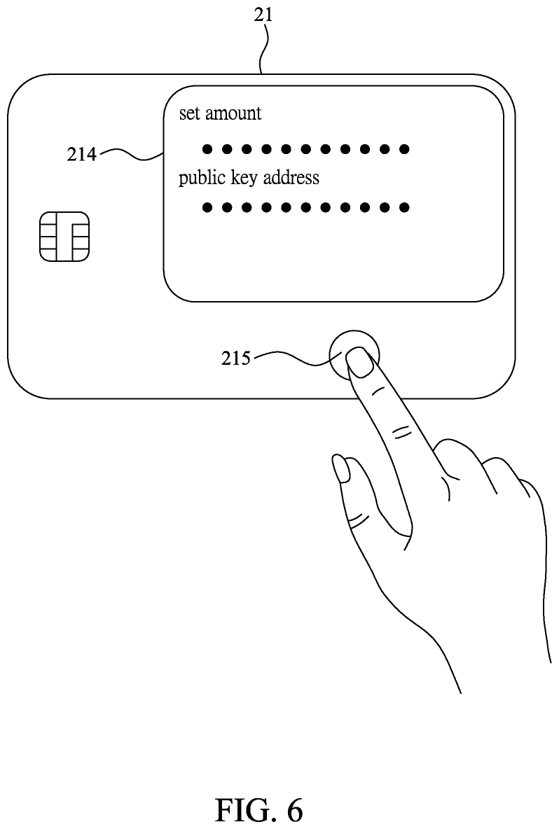

Please refer to FIGS. 1 and 6; subsequently proceed to perform a transaction item re-verifying step S4. When the electronic device 20 generates the verification information, the electronic device 20 sends the transaction item to the storage carrier 21. The microprocessor 211 of the storage carrier 21 acquires the set amount and the public key address and then sends the set amount and the public key address to the display 214 of the storage carrier 21, which makes the display 214 show the set amount and the public key address. Subsequently, the user views again the display 214 to confirm whether both the information content of the set amount and the public key address have errors, and when the user reconfirms that both the information content of the set amount and the public key address have no errors, the user presses the confirmation key 215 displayed on the storage carrier 21, which makes the storage carrier 21 generate a re-verification information indicating that the set amount and the public key address have no errors; conversely, when the user confirms that both the information content of the set amount and the public key address are not correct, the transaction item verifying step S3 has to be re-performed.

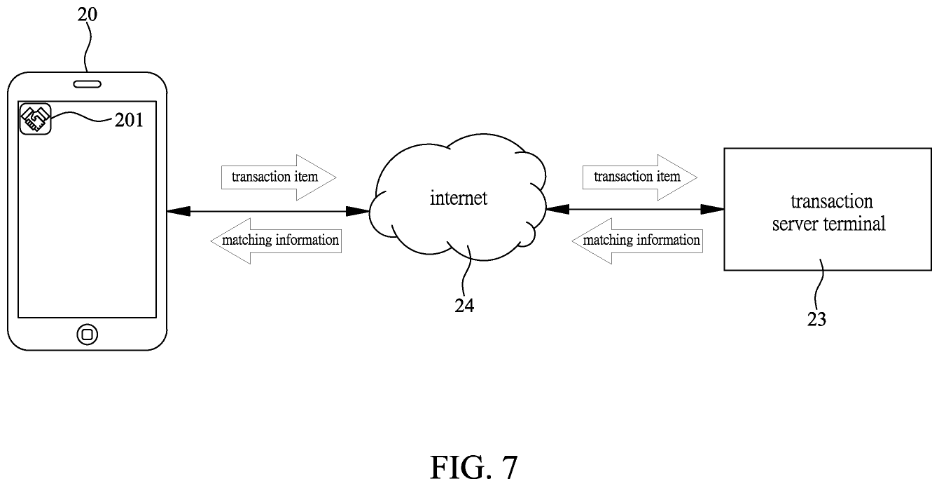

Please refer to FIGS. 1 and 7, after completing the transaction item re-verifying step S4 and proceed to perform a transaction matching step S5. When the storage carrier 21 generates the re-verification information, the storage carrier 21 transmits the transaction item and the re-verification information to the electronic device 20, and the electronic device 20 transmits the transaction item to the transaction server terminal 23 because of receiving the re-verification information; wherein, when the transaction server terminal 23 receives the transaction item, the transaction server terminal 23 matches and compares the just received transaction item to each of the transaction items stored in the transaction server terminal 23; when the transaction server terminal 23 finds that one of the transaction items stored in the transaction server terminal 23 corresponds with the just received transaction item, the transaction server terminal 23 generates a matching information including a transaction address and a transaction amount. The transaction server terminal 23 then sends the matching information to the application software 201 of the electronic device 20.

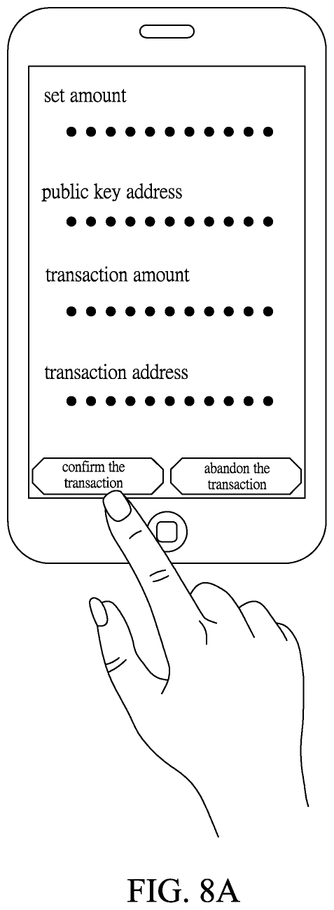

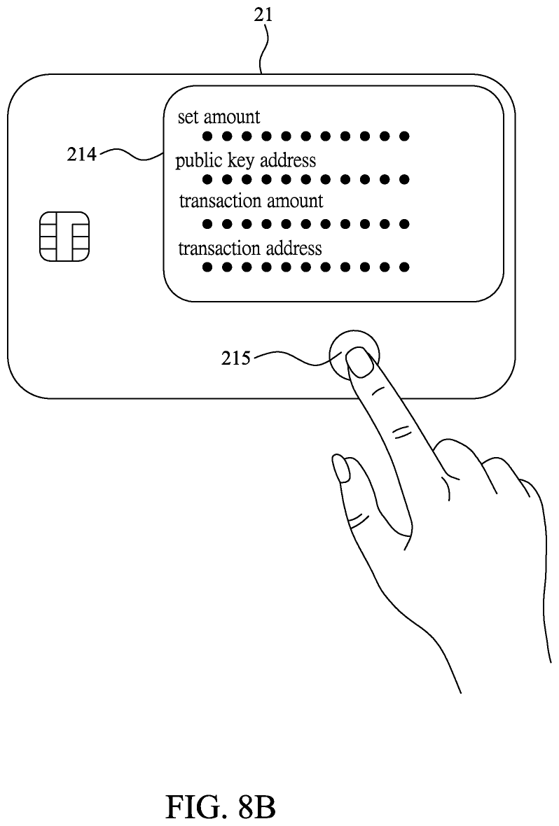

Please refer to FIGS. 1 and 8A. When the application software 201 of the electronic device 20 receives the matching information, the electronic device 20 obtains the transaction amount and the transaction address from the matching information, and the electronic device 20 further shows the transaction amount of the matching information, the transaction address of the matching information, the set amount of the transaction item, and the public key address of the transaction item. Subsequently, the user confirms that the transaction amount of the matching information matches the set amount of the transaction item and confirms that the information content of the public key address of the transaction item is correct, and then the user can press the key “confirm the transaction” displayed on the electronic device 20, thus completing a transaction confirming step S6. When the key “confirm the transaction” is pressed, the electronic device 20 would accept confirmation indication, which makes the electronic device 20 generate confirmation information, and wherein the confirmation indication is used to show that the transaction amount of the transaction item corresponds with the transaction amount of the matching information. Through this, the user oneself can confirm whether the transaction amount of the matching information corresponds with the set amount of the transaction item via the electronic device 20, and confirm whether the public key address of the transaction item is correct, such that the transaction amount and the transaction address avoid being falsified by those who have ulterior motives.

Please refer to FIGS. 1 and 8B. When the electronic device 20 generates the confirmation information, the electronic device 20 sends the transaction item and the matching information to the storage carrier 21, and the microprocessor 211 of the storage carrier 21 instructs the display 214 to show the transaction amount of the matching information, the transaction address of the matching information, the set amount of the transaction item and the public key address of the transaction item; subsequently, the user views again the display 214 to confirm whether the transaction amount of the matching information is consistent with the set amount of the transaction item, and confirms that the information content of the public key address of the transaction item is correct; the user presses the confirmation key 215 on the storage carrier 21, which makes the storage carrier 21 receive re-confirmation indication inputted from the user; thus the storage carrier 21 generates an electronic signature corresponding to the private key information through the re-confirmation indication, and the storage carrier 21 transmits the electronic signature and the matching information to the electronic device 20; conversely, when the user confirms that the transaction amount of the matching information is not consistent with the set amount of the transaction item, or discovers that information content of the public key address has errors, the user could choose to rep-perform the transaction item verifying step S3, and no need to press the confirmation key 215.

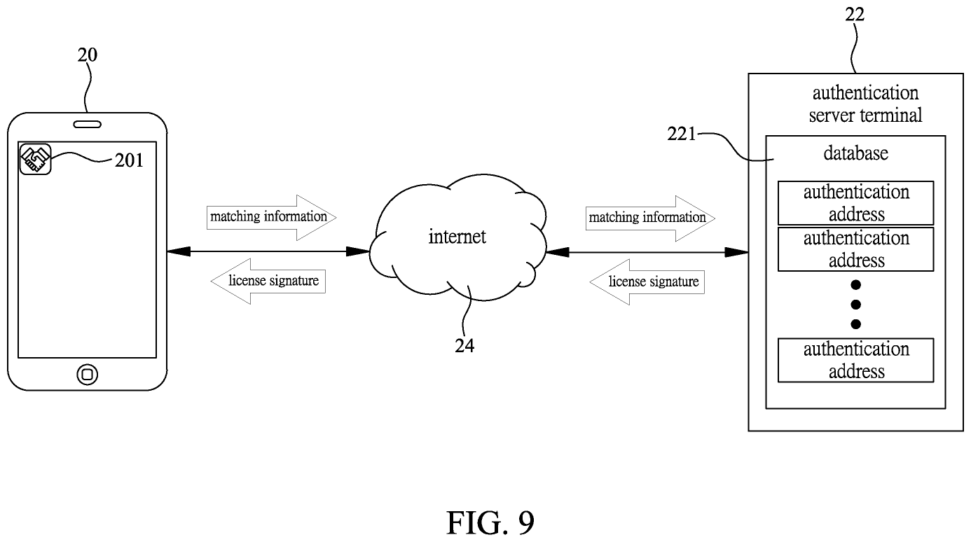

Please refer to FIGS. 1 and 9. After completing the transaction matching step S5, besides performing the transaction confirming step S6, an account confirming step S7 must also be performed. When the application software 201 of the electronic device 20 receives the matching information, the electronic device 20 transmits the matching information to the authentication server terminal 22. Subsequently, the authentication server terminal 22 performs verification between the transaction address of the matching information and the authentication address; when the authentication server terminal 22 finds that the transaction address of the matching information corresponds with the authentication address, the authentication server terminal 22 issues the license signature and transmits the license signature to the electronic device 20; conversely, when the authentication server terminal 22 compares and confirms that the authentication address is not consistent with the transaction address of the matching information, the authentication server terminal 22 would not transmit the license signature to the electronic device 20. Through this, the authentication server terminal 22 can assist the user in confirming whether the transaction address of the matching information is authenticated, thereby preventing the user's digital currency from being transferred to the digital currency account 261 which may be problematic.

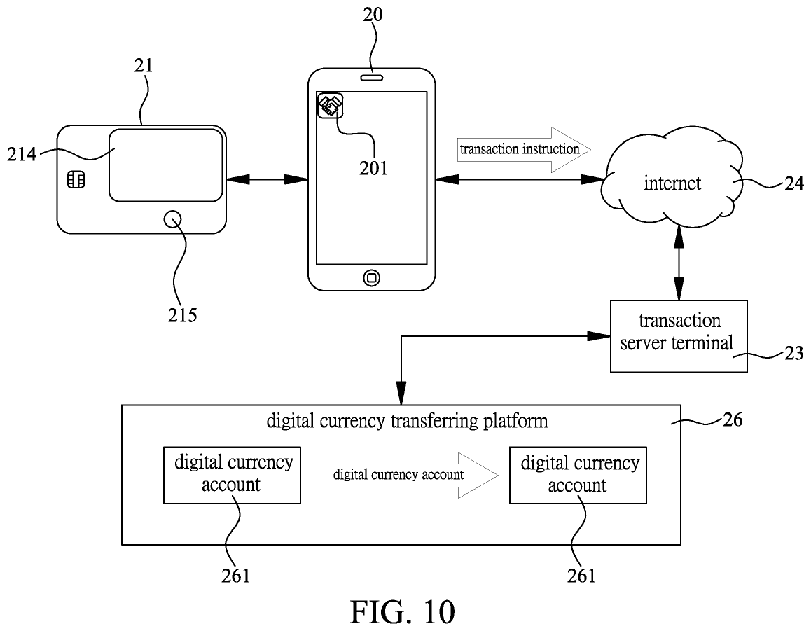

Please refer to FIGS. 1 and 10. After the electronic device 20 obtains the electronic signature and the license signature, proceed to perform a transaction step S8. The electronic device 20 generates a transaction instruction according to the matching information, the electronic signature and the license signature; the electronic device 20 transmits the transaction instruction to the transaction server terminal 23, and because of receiving the electronic signature and the license signature, the transaction server terminal 23 transfers the digital currency of the public key information in one of the digital currency accounts 261 to the public key information of one other digital currency account 261 according to the information content of the matching information. By contrast, the physical currency account 251 receives the physical currency of one other physical currency account 251. Wherein the transaction step S8 cannot be performed when the electronic device 20 does not receive the license signature, and thus even if the transaction server terminal 23 receives the electronic signature, the transaction server terminal 23 still cannot transfer the digital currency of the public key information in one of the digital currency accounts 261 to the public key information of one other digital currency account 261.

The above-instanced embodiments are used for conveniently describing the present invention, not further to limit it. For the person skilled in the art of the disclosure, without departing from the concept of the disclosure, simple modifications or changes can be made and should be included in the following claims and their equivalents of the present application.

What is claimed is:

1. A multiple authentication method for digital asset transaction, comprising
a setting up step of creating a digital currency account capable of storing digital currency, the digital currency account having a piece of public key information and a piece of private key information, and storing the private key information in a storage carrier;
a account authentication step, where an authentication server terminal receives the public key information and performs authentication on the public key information to obtain an authentication address, wherein the authentication server terminal has a license signature, and is able to be used to verify whether the public key information and the authentication address match with each other;
a transaction matching step, where an electronic device obtains the public key information and creates a transaction item including a public key address and a set amount according to the public key information, and the electronic device transmits the transaction item to a transaction server terminal, and accordingly the transaction server terminal matches the transaction items of various users to generate matching information including a transaction address as well as a transaction amount and transmits the matching information to the electronic device;
a transaction confirming step of verifying that the set amount of the transaction item is consistent with the transaction amount of the matching information, which makes the storage carrier generate a electronic signature corresponding to the private key information and transmitting the electronic signature to the electronic device;
a account confirming step, where the electronic device transmits the transaction address of the matching information to the authentication server terminal, and the authentication server terminal performs verification between the transaction address and the authentication address to confirm that the transaction address is consistent with the authentication address, and accordingly the authentication server terminal transmits the license signature to the electronic device; and
a transaction step, where after obtaining the matching information, the electronic signature and the license signature, the electronic device generates a transaction instruction and transmits the transaction instruction to the transaction server terminal to transfer the digital currency of the public key information.

2. The multiple authentication method according to claim 1, wherein before the transaction matching step, the method further comprises:
a transaction item verifying step, where the electronic device obtains the set amount and the public key address, and the electronic device confirms that the set amount and the public key address have no errors to generate verification information, and accordingly the electronic device transmits the transaction item to the transaction server terminal.

3. The multiple authentication method according to claim 2, wherein after the transaction item verifying step, the method further comprises:
a transaction item re-verifying step, when the electronic device generates the verification information, the electronic device transmits the transaction item to the storage carrier, and the storage carrier obtains the set amount and the public key address and confirms that the set amount and the public key address have no errors to generate re-verification information transmitted to the electronic device, and thus the electronic device can transmit the transaction item to the transaction server terminal.

4. The multiple authentication method according to claim 1, wherein in the transaction confirming step, one of the electronic device and the storage carrier obtains the set amount of the transaction item and the transaction amount of the matching information, and performs verification between the set amount of the transaction item and the transaction amount of the matching information.

5. The multiple authentication method according to claim 4, wherein in the transaction confirming step, before the electronic signature is transmitted to the electronic device, the other one of the electronic device and the storage carrier re-verifies that the set amount is consistent with the transaction amount of the matching information.

6. The multiple authentication method according to claim 5, wherein in the transaction confirming step, one of the electronic device and the storage carrier receives confirmation indication inputted by the user, while the other one of the electronic device and the storage carrier receives re-confirmation indication, and accordingly the electronic device and the storage carrier sequentially verify that the set amount is consistent with the transaction amount of the matching information.

7. The multiple authentication method according to claim 1, wherein the authentication server terminal connects to a plurality of various transaction institutions, and the transaction institution can create the digital currency account, thus further generating the public key information and the private key information.

8. The multiple authentication method according to claim 7, wherein when the transaction institution generates the public key information, the transaction institution transmits the public key information to the authentication server terminal, and thus the authentication server terminal authenticates the public key information.
